(19) United States
(12) Patent Application Publication
(10) Pub. No.: US 2024/0386377 A1
(43) Pub. Date: Nov. 21, 2024

(54) DETECTING AND MANAGING CONFLICTS FOR MULTIPLE EXPERIMENTS

(71) Applicant: Adobe Inc., San Jose, CA (US)

(72) Inventors: Elena-Georgiana Copil, Cluj-Napoca (RO); Sumit Ranjan, Milpitas, CA (US); Harleen Sahni, Washington, DC (US)

(73) Assignee: Adobe Inc., San Jose, CA (US)

(21) Appl. No.: 18/197,836

(22) Filed: May 16, 2023

(51) Int. Cl. G06Q 10/10

(52) U.S. Cl. CPC G06Q 10/103

(57) ABSTRACT

In implementations of systems for detecting and managing conflicts for multiple experiments, a computing device implements a management system to assign a first experiment to a first namespace and a second experiment to a second namespace. An indication is received via a network of the first experiment performed via a first channel using a first set of entities and a second set of entities from a group of entities. The management system receives a request via the network to perform the second experiment via a second channel using a third set of entities and a fourth set of entities from the group of entities. The management system detects a conflict for the second experiment based on the first namespace and the second namespace. An indication of the conflict for the second experiment is generated for display in a user interface.

### BACKGROUND

Experiments are commonly performed to evaluate different values of a variable relative to a metric. For example, in order to evaluate an error rate (e.g., a metric) for first and second new versions of an existing application (e.g., first and second values of a variable), an experiment is performed in which the existing application is replaced with the first new version for a first set of users of the existing application. The experiment also replaces the existing application with the second new version for a second set of the users of the existing application. In this example, error logs for the first set of users and error logs for the second set of users are analyzed to evaluate the error rate for the first and second new versions of the application.

### SUMMARY

Techniques and systems for detecting and managing conflicts for multiple experiments are described. In an example, a computing device implements a management system to assign a first experiment to a first namespace and a second experiment to a second namespace. For example, the first namespace defines a first logical grouping of experiments to be performed using mutually exclusive sets of entities and the second namespace defines a second logical grouping of experiments which are to be performed using mutually exclusive sets of entities.

The management system receives an indication via a network of the first experiment performed via a first channel using a first set of entities and a second set of entities from a group of entities. In one example, the management system receives a request via the network to perform the second experiment via a second channel using a third set of entities and a fourth set of entities from the group of entities. In this example, the management system detects a conflict for the second experiment based on the first namespace and the second namespace. An indication of the conflict for the second experiment is generated for display in a user interface.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of an environment in an example implementation that is operable to employ digital systems and techniques for detecting and managing conflicts for multiple experiments as described herein.

FIG. 2 depicts a system in an example implementation showing operation of a management module for detecting and managing conflicts for multiple experiments.

FIG. 3 illustrates a representation of experiment data, namespace data, and ID data.

FIG. 4 illustrates a representation of detecting a conflict based on lineage of a campaign.

FIG. 5 illustrates a representation of detecting a conflict based on parallel experiments evaluating a same variable.

FIG. 6 illustrates a representation of detecting a conflict based on a particular entity included in multiple sets of entities.

FIG. 7 illustrates a representation of detecting and managing conflicts for multiple experiments.

FIG. 8 illustrates a representation of a report generated using systems for detecting and managing conflicts for multiple experiments.

FIG. 9 is a flow diagram depicting a procedure in an example implementation in which a conflict is detected for a second experiment based on a first namespace and a second namespace.

FIG. 10 is a flow diagram depicting a procedure in an example implementation in which an indication of a conflict for a second experiment is generated for display in a user interface.

FIG. 11 illustrates an example system that includes an example computing device that is representative of one or more computing systems and/or devices for implementing the various techniques described herein.

### DETAILED DESCRIPTION

### Overview

Experiments are often performed to evaluate different values of a variable using sets of entities from a group of entities. In one example, an experiment is performed to evaluate a first value of the variable using a first set of entities from the group of entities and a second value of the variable using a second set of entities from the group of entities. In this example, a signification challenge in designing and performing the experiment involves ensuring that the experiment is free from conflicts such as biases which cause results of the experiment to be unreliable or invalid. For instance, if a particular entity is included in the first set of entities and also included in the second set of entities, then there is a conflict for the experiment because the particular entity is used to evaluate both the first value and the second value of the variable.

Conventional systems for detecting and managing conflicts for the experiment are limited to manual evaluations of the experiment's design, the first set of entities, and the second set of entities, for example, to ensure that no entity identifications included in the first set of entities are also included in the second set of entities. These manual evaluations are both inefficient and unlikely to identify a conflict in a scenario in which the experiment is performed via multiple channels that associate the particular entity with multiple different identifications. This is because the particular entity has a first identification in the first set of entities based on a first channel (e.g., a website) and the particular entity has a second identification in the second set of entities based on a second channel (e.g., an application of mobile device).

In order to overcome the limitations of conventional systems, techniques and systems for detecting and managing conflicts for multiple experiments are described. In an example, a computing device implements a management system to assign a first experiment to a first namespace and a second experiment to a second namespace. In this example, the first namespace defines a first logical grouping of experiments to be performed using mutually exclusive sets of entities and the second namespace defines a second logical grouping of experiments to be performed using mutually exclusive sets of entities.

For instance, the management system receives an indication via a network of the first experiment performed via a first channel using a first set of entities and a second set of entities from a group of entities. In one example, the management system accesses or receives an identification graph of identifications associated with entities included in the first set of entities and identifications associated with entities included in the second set of entities. In some examples, the management system performs identity stitching using the identification graph. The identity stitching identifies each different identification of a particular entity and associates each of the different identifications with the particular entity such that it is possible for the management system to determine whether the particular entity is included in both the first set of entities and the second set of entities.

The management system receives a request via the network to perform the second experiment via a second channel using a third set of entities and a fourth set of entities from the group of entities. Consider an example in which the first experiment evaluates first values of a variable using the first and second sets of entities and the second experiment is designed to evaluate second values of the variable (or second values of another variable that is similar to the variable). In this example, the management system detects a conflict for the second experiment based on the first namespace and the second namespace because all values of the variable (or the similar variable) are to be evaluated within the first namespace. Continuing the example, the management system resolves the conflict for the second experiment by assigning the second experiment to the first namespace.

Consider an additional example in which the first experiment evaluates a first value of a variable using the first set of entities and evaluates a second value of the variable using the second set of entities. In this additional example, the management system leverages the different identifications associated with the particular entity to determine that the particular entity is included in both the first set of entities and the second set of entities. For instance, the management system detects a conflict for the first experiment because the particular entity is used to evaluate both the first value and the second value of the variable. In one example, the management system generates an indication of the conflict for the first experiment for display in a user interface.

By utilizing namespaces to define logical groupings of experiments to be performed using mutually exclusive sets of entities and by performing identity stitching using the identification graph to associate multiple different identifications with corresponding entities, the management system is capable of automatically detecting and managing conflicts for multiple experiments. This is not possible using conventional systems which are limited to manually evaluating experiment designs and evaluation targets in order to detect conflicts. For instance, the described systems for detecting and managing conflicts for multiple experiments are capable of performing the multiple experiments in parallel using one group of entities by assigning each of the multiple experiments to a different namespace. This is a further improvement relative to the conventional systems which are limited to performing multiple experiments sequentially in order to prevent conflicts which is inefficient.

### Term Examples

As used herein, the term “experiment” refers to an evaluation of at least one variable that is performed using at least one set of entities.

As used herein, the term “variable” refers to a state or characteristic which is capable of having different values. By way of example, a background color of an electronic document is a variable that is capable of having different values such as white, red, green, blue, black, etc.

As used herein, the term “channel” refers to a means or mechanism for performing an experiment using at least one set of entities. By way of example, the experiment is performable via a network based (e.g., a web-based) channel such as a website, a channel of a mobile device (e.g., an application of a smartphone), a short messaging service channel, an electronic communications channel, and so forth.

As used herein, the term “namespace” refers to a logical grouping of experiments to be performed using mutually exclusive sets of entities. For example, a first set of entities and a second set of entities are mutually exclusive sets of entities if no particular entity is included in both the first set of entities and the second set of entities.

As used herein, the term “conflict” for an experiment refers to an occurrence or a non-occurrence of an event which causes an outcome or result of the experiment to be invalid, inconclusive, unreliable, etc. Examples of conflicts for the experiment include non-random or biased selection of sets of entities used to perform the experiment, an additional experiment which is assigned to a different namespace than a namespace of the experiment and that evaluates a same variable evaluated in the experiment, and so forth.

In the following discussion, an example environment is first described that employs examples of techniques described herein. Example procedures are also described which are performable in the example environment and other environments. Consequently, performance of the example procedures is not limited to the example environment and the example environment is not limited to performance of the example procedures.

### Example Environment

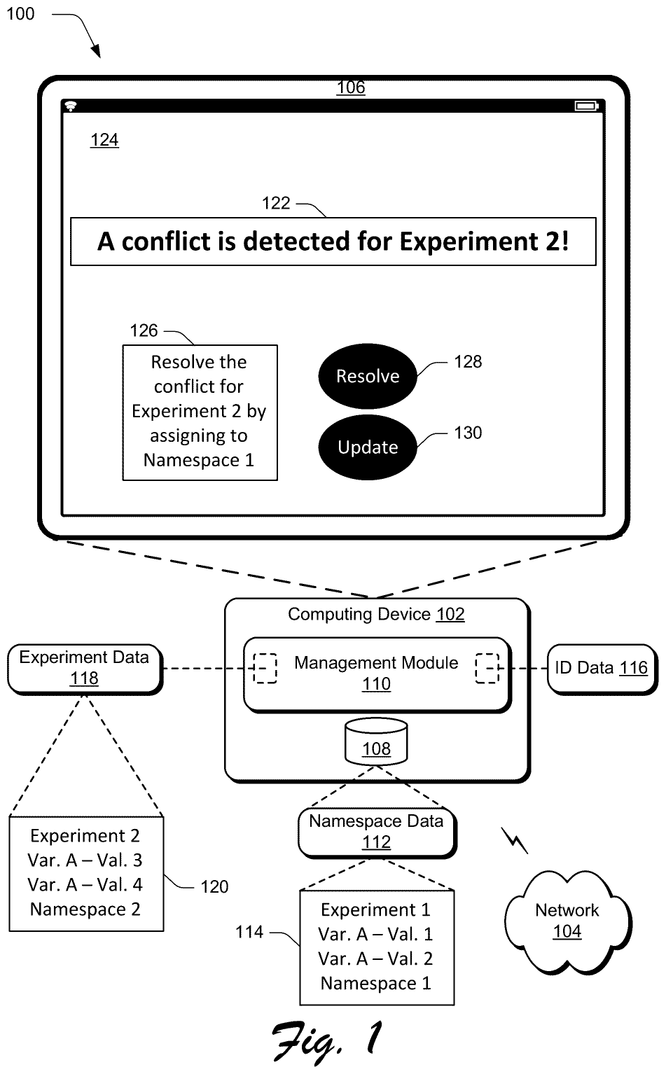

FIG. 1 is an illustration of an environment 100 in an example implementation that is operable to employ digital systems and techniques as described herein. The illustrated environment 100 includes a computing device 102 connected to a network 104. The computing device 102 is configurable as a desktop computer, a laptop computer, a mobile device (e.g., assuming a handheld configuration such as a tablet or mobile phone), and so forth. Thus, the computing device 102 is capable of ranging from a full resource device with substantial memory and processor resources (e.g., personal computers, game consoles) to a low-resource device with limited memory and/or processing resources (e.g., mobile devices). In some examples, the computing device 102 is representative of a plurality of different devices such as multiple servers utilized to perform operations “over the cloud.”

The illustrated environment 100 also includes a display device 106 that is communicatively coupled to the computing device 102 via a wired or a wireless connection. A variety of device configurations are usable to implement the computing device 102 and/or the display device 106. For instance, the computing device 102 includes a storage device 108 and a management module 110. The storage device 108 is illustrated to include namespace data 112 describing namespace information 114.

In an example, the namespace information 114 describes namespaces, variables, and other information for designed experiments and running experiments. For example, a namespace defines a logical grouping of experiments to be performed using mutually exclusive sets of entities. As shown, the namespace information 114 describes that “Experiment 1” is evaluating “Var. A-Val. 1” and “Var. A-Val. 2” within “Namespace 1.” Although the namespace information 114 is illustrated as describing one experiment evaluating two values of a single variable within one namespace in an example, it is to be appreciated that, in other examples, the namespace information 114 describes many experiments evaluating different variables having a multitude of different values within multiple different namespaces.

The management module 110 is illustrated as having, receiving, and/or transmitting ID data 116. In one example, the ID data 116 describes an identification graph of identifications of entities used to perform experiments via different channels. In this example, it is possible to for a particular entity to be associated with a first identification for an experiment performed via a first channel and also to be associated with a second identification for another experiment performed via a second channel. The management module 110 receives and processes the ID data 116 using identity stitching to associate identifications with entities such as by associating the first identification with the second identification and by associating the particular entity with the first identification and the second identification.

For instance, the management module 110 is illustrated as having, receiving, and/or transmitting experiment data 118 describing experiment information 120. As shown, the experiment information 120 describes an experiment being designed and/or an experiment which is about to be performed. In the illustrated example, the experiment information 120 describes that “Experiment 2” will evaluate “Var. A-Val. 3” and “Var. A-Val. 4” within “Namespace 2.”

The management module 110 receives and processes the namespace data 112, the ID data 116, and the experiment data 118 to detect a conflict for “Experiment 2.” As illustrated in FIG. 1, an indication 122 of the conflict for “Experiment 2” is displayed in a user interface 124 of the display device 106. The indication 122 states “A conflict is detected for Experiment 2!” For example, the management module 110 detects the conflict for “Experiment 2” because “Experiment 2” evaluates values of “Var. A” within “Namespace 2” and the namespace information 114 indicates that “Experiment 1” evaluates values of “Var. A” within “Namespace 1.” In this example, the conflict for “Experiment 2” is based on a potential evaluation of “Var. A” within different namespaces (“Namespace 1” and “Namespace 2”) which could cause results of “Experiment 2” and/or “Experiment 1” to be unreliable or invalid because “Namespace 1” defines a logical grouping of experiments to be performed using mutually exclusive sets of entities and “Namespace 2” also defines a logical grouping of experiments to be performed using mutually exclusive sets of entities.

Consider an example in which “Var. A” is a variable for a header of an instance of digital content to be generated based on the results of “Experiment 1” and “Experiment 2.” In this example, the variable for the header is a type of font used to render glyphs of text included in the header of the instance of digital content. Accordingly, “Val. 1” represents a first type of font; “Val. 2” represents a second type of font; “Val. 3” represents a third type of font; and “Val. 4” represents a fourth type of font.

Continuing the example, “Experiment 1” is performed using a first set of entities to evaluate “Val. 1” and using a second set of entities to evaluate “Val. 2” such that the first and second sets of entities are mutually exclusive. For example, no particular entity is included in the first set of entities and also included in the second set of entities. “Experiment 2” is performed using a third set of entities to evaluate “Val. 3” and using a fourth set of entities to evaluate “Val. 4” such that the third and fourth sets of entities are mutually exclusive. For instance, no particular entity is included in the third set of entities and also included in the fourth set of entities.

However, the first set of entities and the third set of entities are not mutually exclusive, and the first set of entities and the fourth set of entities are also not mutually exclusive. Similarly, the second set of entities and the third set of entities are not mutually exclusive, and the second set of entities and the fourth set of entities are not mutually exclusive. As a result, it is possible that a particular entity is included in the first or second set of entities and also included in the third or fourth set of entities which is a conflict since both “Experiment 1” and “Experiment 2” evaluate the same “Var. A” which causes results of “Experiment 1” and/or “Experiment 2” to be invalid or unreliable.

In order to resolve the detected conflict for “Experiment 2,” the management module 110 generates a resolution indication 126 which is displayed in the user interface 124. In the illustrated example, the resolution indication 126 states “Resolve the conflict for Experiment 2 by assigning to Namespace 1.” For example, the management module 110 also generates and displays user interface elements 128, 130 in the user interface 124. In an example, a user manipulates an input device (e.g., a mouse, a stylus, a keyboard, a microphone, a touchscreen, etc.) relative to the user interface 124 to interact with user interface element 128 to resolve the conflict for “Experiment 2” by assigning “Experiment 2” to “Namespace 1.” In another example, the user manipulates the input device relative to the user interface 124 to interact with user interface element 130 to update the experiment information 120 such as by changing “Var. A” to a different variable (e.g., “Var. B”) or by manually assigning “Experiment 2” to “Namespace 1.”

By detecting and managing conflicts for multiple experiments in this way, the management module 110 increases a reliability of results of the multiple experiments and a rate at which the multiple experiments can be performed, e.g., non-conflicting experiments assigned to different namespaces are performable in parallel using a same set of entities. By leveraging the ID data 116, the management module 110 is also capable of generating accurate reports based on performing single experiments via multiple different channels (e.g., considering all events associated with a specific entity having different identifications for each of the different channels). Furthermore, the ID data 116 is also usable to automatically detect conflicts based on a first experiment to be performed via a first channel using a first set of entities and a second experiment to be performed via a second channel using a second set of entities by identifying a particular entity that is associated with a first identification in the first set of entities and that is also associated with a second identification in the second set of entities. This is not possible in conventional systems that are limited to manually checking experiments, variables, and sets of entities used to evaluate the variables in the experiments in order to identify and/or prevent conflicts.

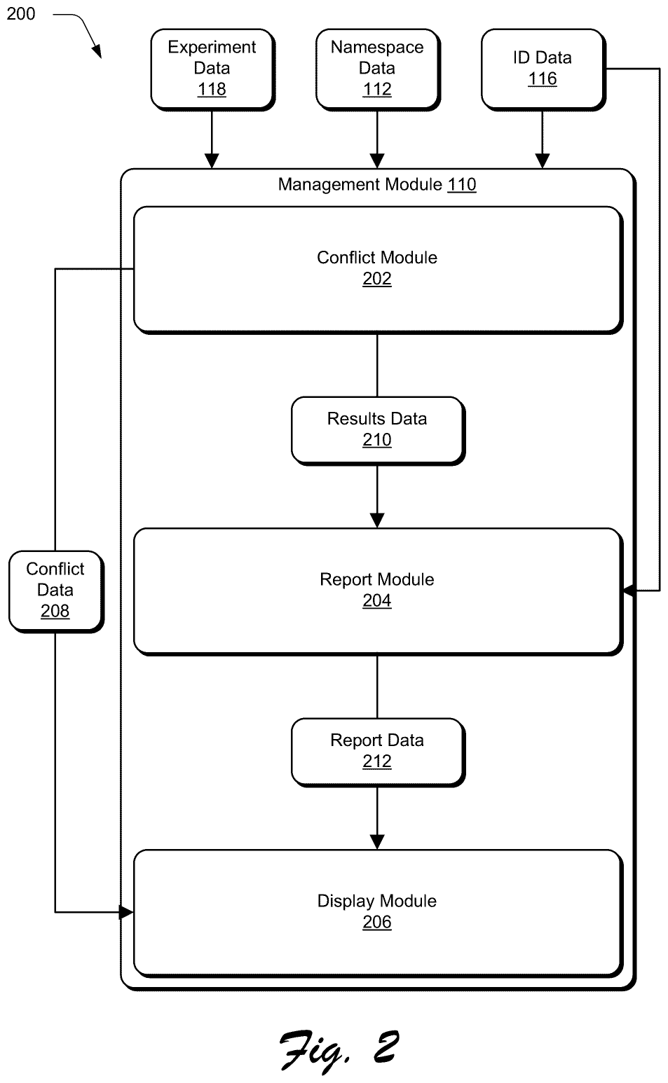

FIG. 2 depicts a system 200 in an example implementation showing operation of a management module 110. The management module 110 is illustrated to include a conflict module 202, a report module 204, and a display module 206. For example, the conflict module 202 receives and processes the namespace data 112, the ID data 116, and the experiment data 118 in order to generate conflict data 208 or results data 210.

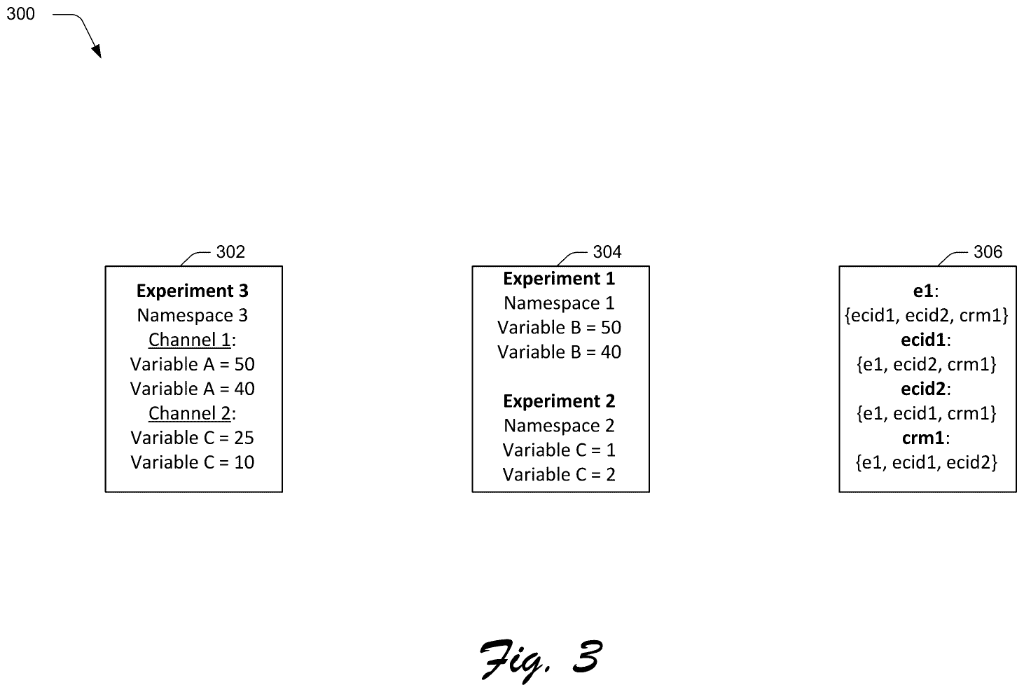

FIG. 3 illustrates a representation 300 of experiment data 118, namespace data 112, and ID data 116. As shown, the representation 300 includes an example 302 of the experiment data 118. In the example 302, “Experiment 3” is assigned to “Namespace 3” in order to evaluate values of “Variable A” via “Channel 1” and values of “Variable C” via “Channel 2.” For instance, “Experiment 3” is being designed or is about to be performed, and “Namespace 3” defines a logical grouping of experiments to be performed using mutually exclusive sets of entities. As illustrated in the example 302, “Experiment 3” evaluates a value of “50” for “Variable A” and a value of “40” for “Variable A” via “Channel 1” and “Experiment 3” evaluates a value of “25” for “Variable C” and a value of “10” for “Variable C” via “Channel 2.”

The representation 300 also includes an example 304 of the namespace data 112. The example 304 indicates that “Experiment 1” is assigned to “Namespace 1” and evaluates a value of “50” for “Variable B” and a value of “40” for “Variable B.” “Namespace 1” defines a logical grouping of experiments to be performed using mutually exclusive sets of entities. The example 304 also indicates that “Experiment 2” is assigned to “Namespace 2” which defines a logical grouping of experiments to be performed using mutually exclusive sets of entities. For example, “Experiment 2” evaluates a value of “1” for “Variable C” and a value of “2” for “Variable C.”

An example 306 of the ID data 116 is included in the representation 300, and the example 306 depicts a portion of an identification graph of identifications of entities used to perform experiments via different channels. In an example, a particular entity has a different identification for each of the different channels, and identity stitching is performable based on the identification graph to associate the particular entity with each of the different identifications. As shown, the example 306 indicates that entity “e1” is associated identification “ecid1,” identification “ecid2,” and identification “crm1.” The example 306 also indicates that the identification “ecid1” is associated with the entity “e1” as well as the identification “ecid2” and the identification “crm1.” For instance, the example 306 further indicates that the identification “ecid2” is associated with the entity “e1,” the identification “ecid1,” and the identification “crm1.” Finally, the example 306 indicates that the identification “crm1” is associated with the entity “e1,” the identification “ecid1,” and the identification “ecid2.” Because the example 306 of the ID data 116 associates entities and different identifications in this way, it is possible to consider all events associated with the entities for accurate reporting and detecting and managing conflicts for multiple experiments performed via multiple different channels.

In a first example, the conflict module 202 receives and processes the namespace data 112, the ID data 116, and the experiment data 118 to detect a conflict for “Experiment 3.” In this first example, the detected conflict for “Experiment 3” which is assigned to “Namespace 3” is based on “Experiment 2” which is assigned to “Namespace 2” because both “Experiment 2” and “Experiment 3” evaluate values for “Variable C.” In a second example, the conflict module 202 detects a conflict for “Experiment 3” based on the example 306 of the ID data 116. In the second example, the conflict module 202 determines that “Experiment 1” was performed using a set of entities that includes the identification “crm1” which is associated with the entity “e1.” The conflict module 202 also determines that “Experiment 3” is to be performed using a set of entities that includes the identification “ecid1” which is also associated with the entity “e1.” In the first and second examples, the conflict module 202 generates the conflict data 208 as describing the detected conflict for “Experiment 3” and the display module 206 receives and processes the conflict data 208 to generate an indication of the detected conflict for “Experiment 3” for display in the user interface 124.

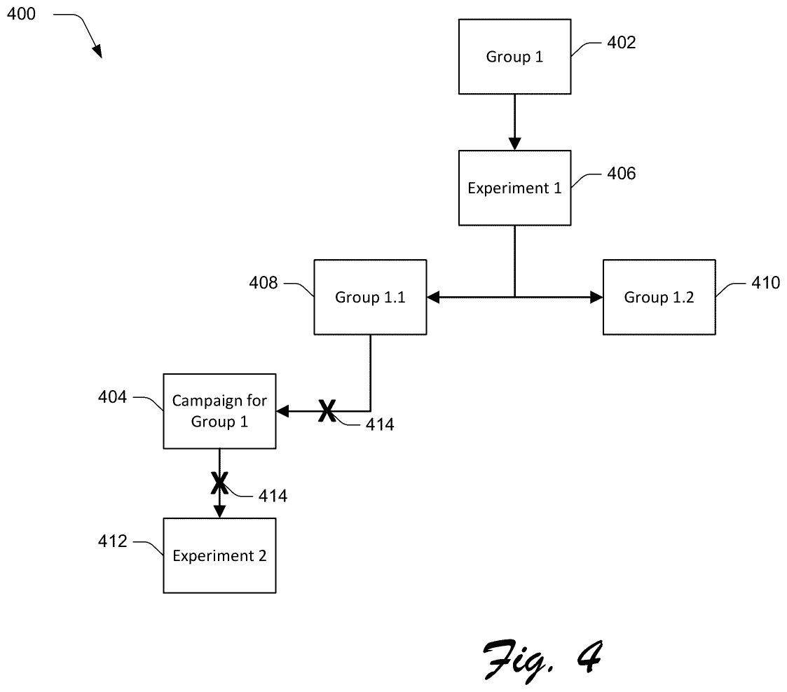

FIG. 4 illustrates a representation 400 of detecting a conflict based on lineage of a campaign. The representation 400 includes a group 402 “Group 1” and a campaign 404 “Campaign for Group 1” that is defined specifically for the group 402. However, a first experiment 406 “Experiment 1” has split the group 402 into a first subgroup 408 “Group 1.1” and a second subgroup 410 “Group 1.2.” As a result of this split, a second experiment 412 “Experiment 2” has a conflict 414 based on a lineage of a campaign objective.

For example, the conflict 414 is generated because the campaign 404 is defined specifically for the group 402 but the first experiment 406 splits or segments the group 402 into the first subgroup 408 and the second subgroup 410. In an example, the conflict module 202 generates the conflict data 208 as describing the conflict 414. In this example, the display module 206 receives and processes the conflict data 208 to generate an indication of the conflict 414 for display in the user interface 124.

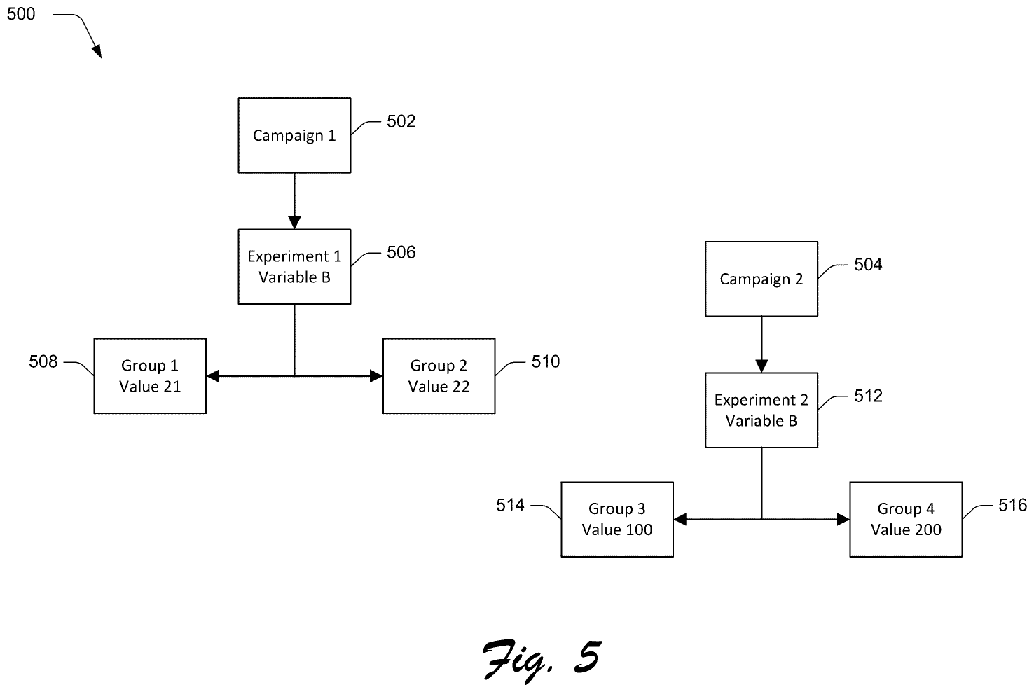

FIG. 5 illustrates a representation 500 of detecting a conflict based on parallel experiments evaluating a same variable. The representation 500 includes a first campaign 502 “Campaign 1” and a second campaign 504 “Campaign 2.” In an example, the first campaign 502 and the second campaign 504 are conducted in parallel. For instance, the first campaign 502 includes a first experiment 506 “Experiment 1” which evaluates values of “Variable B.”

In one example, “Variable B” is for hero digital image to be included in digital content. In this example, a first group 508 “Group 1” is used to evaluate “Value 21” of “Variable B” and a second group 510 “Group 2” is used to evaluate “Value 22” of “Variable B.” Consider an example in which “Value 21” represents a first editing operation (e.g., a first filter) applied to the hero digital image and “Value 22” represents a second editing operation (e.g., a second filter) applied to the hero digital image.

As shown, the second campaign 504 includes a second experiment 512 “Experiment 2” which also evaluates values of “Variable B.” A third group 514 “Group 3” is used to evaluate “Value 100” of “Variable B” and a fourth group 516 “Group 4” is used to evaluate “Value 200” of “Variable B.” For example, “Value 100” represents a third editing operation (e.g., a first preset) applied to the hero digital image and “Value 200” represents a fourth editing operation (e.g., a second preset) applied to the hero digital image.

The conflict module 202 detects a conflict for the first experiment 506 and the second experiment 512 because both experiments are evaluating values of “Variable B.” For example, the third editing operation includes the first editing operation, and the fourth editing operation includes the second editing operation. The conflict module 202 generates the conflict data 208 as describing the detected conflict for the first experiment 506 and the second experiment 512. In an example, the display module 206 receives and processes the conflict data 208 to generate an indication of the detected conflict for the first experiment 506 and the second experiment 512 for display in the user interface 124.

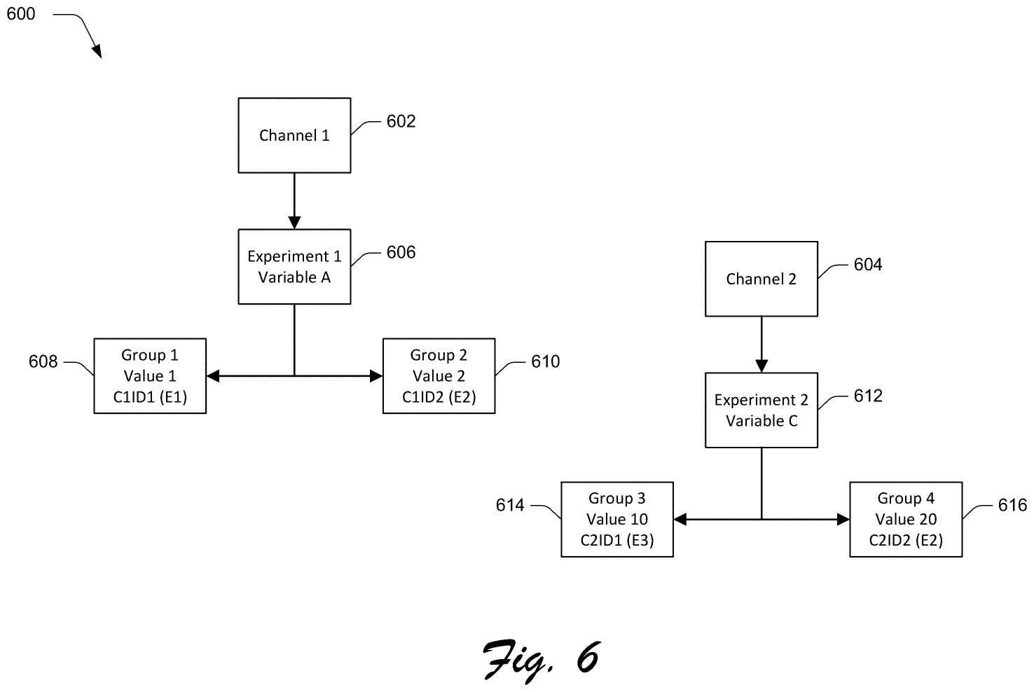

FIG. 6 illustrates a representation 600 of detecting a conflict based on a particular entity included in multiple sets of entities. The representation 600 includes a first channel 602 “Channel 1” and a second channel 604 “Channel 2.” For example, the first channel 602 is a push channel for mobile computing devices (e.g., smartphones) and the second channel 604 is a pull channel implemented via the network 104 (e.g., websites).

A first experiment 606 “Experiment 1” evaluates values of “Variable A” via the first channel 602. For instance, a first group 608 “Group 1” is used to evaluate “Value 1” of “Variable A” and a second group 610 “Group 2” is used to evaluate “Value 2” of “Variable A.” The first group 608 includes an entity “(E1)” associated with an identification “C1ID1.” In some examples, the conflict module 202 associates the entity “(E1)” and the identification “C1ID1” by performing identity stitching using the identification graph described by the ID data 116. As shown, the second group 610 includes an entity “(E2)” associated with an identification “C1ID2.”

A second experiment 612 “Experiment 2” evaluates values of “Variable C” via the second channel 604. For the second experiment 612, a third group 614 “Group 3” is used to evaluate “Value 10” of “Variable C,” and a fourth group 616 “Group 4” is used to evaluate “Value 20” of “Variable C.” The third group 614 includes an entity “(E3)” associated with an identification “C2ID1.” For instance, the fourth group 616 includes the entity “(E2)” associated with an identification “C2ID2.”

In an example, the conflict module 202 detects a conflict because the entity “(E2)” is included in the second group 610 and the entity “(E2)” is also included in the fourth group 616. In this example, the conflict module 202 detects the conflict even though the identification “C1ID2” in the second group 610 is different from the identification “C2ID2” in the fourth group 616 because the entity “(E2)” is associated with the identification “C1ID2” and the entity “(E2)” is also associated with the identification “C2ID2.” For example, the conflict module 202 generates the conflict data 208 as describing the detected conflict and the display module 206 receives and processes the conflict data 208 to generate an indication of the detected conflict for display in the user interface 124.

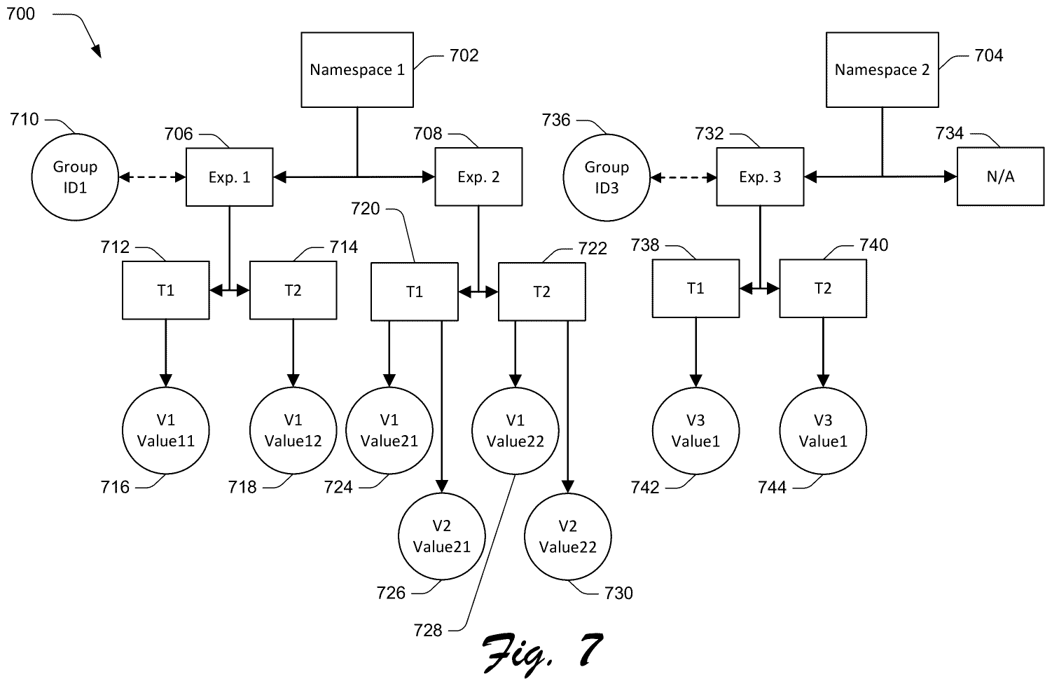

FIG. 7 illustrates a representation 700 of detecting and managing conflicts for multiple experiments. The representation 700 includes a first namespace 702 “Namespace 1” which defines a first logical grouping of experiments to be performed on mutually exclusive sets of entities. For instance, the representation 700 also includes a second namespace 704 “Namespace 2” which defines a second logical grouping of experiments to be performed on mutually exclusive sets of entities. In some examples, the first and second namespaces 702, 704 are usable to detect and prevent conflicts such as performing simultaneous/parallel experiments which evaluate values of a same or similar variable. In other examples, the first and second namespaces 702, 704 are used to obfuscate identifications of particular entities included in sets of entities used to perform experiments to evaluate values of variables.

Notably, the first namespace 702 and the second namespace 704 facilitate simultaneous performance of multiple experiments (e.g., without causing conflicts) using one group of entities in some examples. For example, it is possible for a header experiment assigned to the first namespace 702 that evaluates values of a header variable for a particular instance of digital content using the one group of entities to be performed in parallel with a footer experiment assigned to the second namespace 704 that evaluates values of a footer variable for the particular instance of digital content using the one group of entities without causing a conflict. In conventional systems, the header experiment and the footer experiment are performed sequentially (e.g., to prevent conflicts) which is inefficient.

As shown in the representation 700, a first experiment 706 “Exp. 1” is assigned to the first namespace 702 and a second experiment 708 “Exp. 2” is also assigned to the first namespace 702. In an example, a user designing the first experiment 706 assigns the first experiment 706 to the first namespace 702. In another example, the user designing the first experiment 706 assigns the first experiment 706 to a different namespace which causes the conflict module 202 to detect a conflict. In this example, the conflict module 202 generates the conflict data 208 as describing the detected conflict, and the display module 206 receives and processes the conflict data 208 to display an indication of the detected conflict in the user interface 124. For instance, the user manipulates an input device (e.g., a stylus, a mouse, a touchscreen, a keyboard, a microphone, etc.) relative to the user interface 124 to interact with the user interface element 128 to resolve the detected conflict by assigning the first experiment 706 to the first namespace 702.

The first and second experiments 706, 708 are performed using sets of entities associated with a first identification 710 “Group ID1.” Although the first identification 710 is illustrated as a single identification, it is to be appreciated that the first identification 710 is representative of an identification (e.g., a unique identification) of each entity included in the sets of entities used to perform the first and second experiments 706, 708. In one example, the conflict module 202 receives the ID data 116 as describing the first identification 710 as being associated with the first and second experiments 706, 708. In another example, the conflict module 202 determines the first identification 710 by performing identity stitching using the identification graph described by the ID data 116.

For example, the first experiment 706 includes a first treatment 712 “T1” and a second treatment 714 “T2.” In this example, the first treatment 712 evaluates a first value 716 “Value11” of variable “V1” using a set of entities having the first identification 710 and the second treatment 714 evaluates a second value 718 “Value12” of variable “V1” using another set of entities having the first identification 710. For instance, the second experiment 708 includes a first treatment 720 “T1” and a second treatment 722 “T2.” The first treatment 720 evaluates a third value 724 “Value21” of variable “V1” and a first value 726 “Value21” of variable “V2.” As shown in FIG. 7, the second treatment 722 evaluates a fourth value 728 “Value22” of variable “V1” and a second value 730 “Value22” of variable “V2.”

A third experiment 732 “Exp. 3” is assigned to the second namespace 704 along with an unallocated placeholder 734. For example, the third experiment 732 is performed using sets of entities associated with a second identification 736 “Group ID3.” Like the first identification 710, it is to be appreciated that the second identification 736 is representative of an identification (e.g., a unique identification) of each entity included in the sets of entities used to perform the third experiment 732. The third experiment 732 includes a first treatment 738 “T1” and a second treatment 740 “T2.” For instance, the first treatment 738 evaluates a first value 742 “Value1” of variable “V3” and the second treatment 740 evaluates a second value “Value2” of variable “V3.”

Consider a first example in which the third experiment 732 also evaluates values of variable “V2” and the user interacts with the input device to assign the third experiment 732 to the second namespace 704. In this first example, the conflict module 202 detects a conflict for the third experiment 732 because variable “V2” is also being evaluated by the second experiment 708 which is assigned to the first namespace 702. Consider a second example in which the third experiment 732 is to be performed using sets of entities associated with the first identification 710. In the second example, the conflict module 202 detects a conflict because the first and second experiments 706, 708 are also to be performed using sets of entities associated with the first identification 710.

In the example illustrated in the representation 700, the conflict module 202 receives and processes the namespace data 112 (e.g., describing the first and second namespaces 702, 704), the ID data 116 (e.g., describing the first and second identifications 710, 736), and the experiment data 118 (e.g., describing the first, second, and third experiments 706, 708, 732) and the conflict module 202 does not detect any conflicts. Accordingly, the conflict module 202 generates results data 210 describing results of the first experiment 706, results of the second experiment 708, and results of the third experiment 732. For instance, the report module 204 receives and processes the results data 210 and/or the ID data 116 in order to generate report data 212.

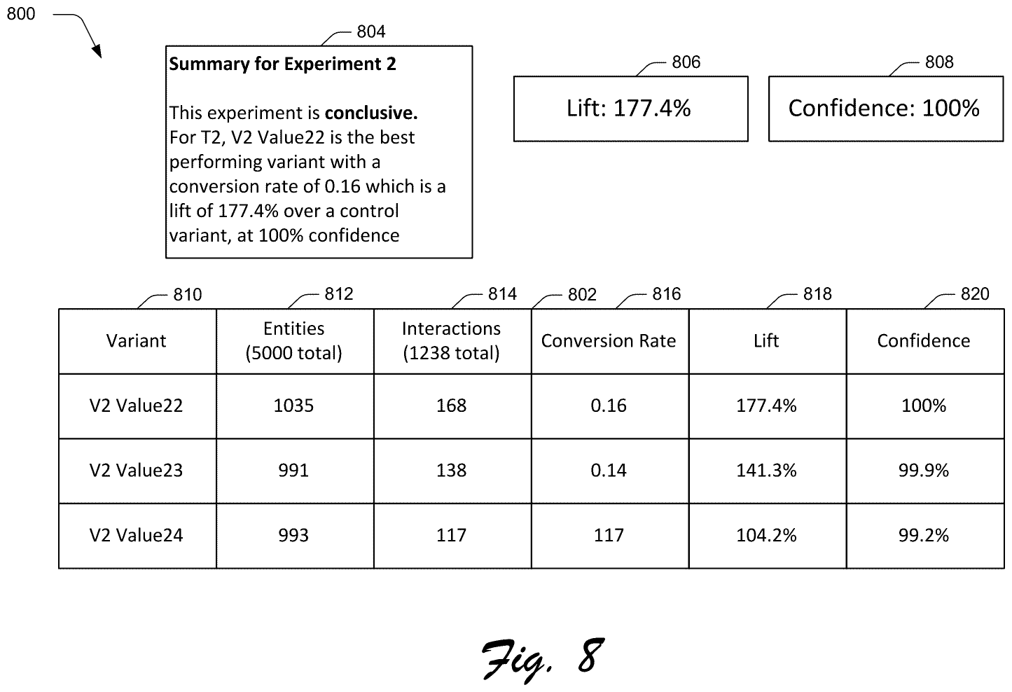

FIG. 8 illustrates a representation 800 of a report generated using systems for detecting and managing conflicts for multiple experiments. As shown in the representation 800 the report data 212 describes a report 802 summarizing results of the second experiment 708. In an example, the display module 206 receives and processes the report data 212 to generate the report 802 for display in the user interface 124. For example, the display module 206 generates and displays an indication 804 of a report summary in the user interface.

The indication 804 states “This experiment is conclusive. For T2, V2 Value22 is the best performing variant with a conversion rate of 0.16 which is a lift of 177.4% over a control variant, at 100% confidence.” In one example, the display module 206 also generates an indication 806 of the lift which states “Lift: 177.4%” and an indication 808 of the confidence which states “Confidence: 100%.” In this example, the report 802 indicates variants 810 evaluated in the second experiment 708, entities 812 associated with the first identification 710 used to evaluate the variants 810, interactions 814 for the variants 810, conversion rates 816 for the variants 810, lift 818 for the variants 810, and confidence 820 for the variants 810.

For instance, by utilizing namespaces to define logical groupings of experiments to be performed using mutually exclusive sets of entities and by performing identity stitching using the identification graph described by the ID data 116 to associate different identifications based on different channels with particular entities, the management module 110 is capable of automatically generating the report 802 without causing conflicts. This is an improvement relative to conventional systems in which conflicts are identified by manually checking experiments, variables, and sets of entities used to evaluate the variables in the experiments in order to identify and/or prevent conflicts. Moreover, by utilizing the namespaces to define the logical groups of experiments to be performed using mutually exclusive sets of entities, the described systems for detecting and managing conflicts for multiple experiments are capable of performing a first experiment evaluating values of a first variable and simultaneously performing a second experiment evaluating values of a second variable using one group of entities without causing conflicts or invaliding results of the first and second experiments. This is not possible using the conventional systems that are limited to performing the first and second experiments sequentially in order to avoid causing conflicts which is inefficient for scenarios in which the first and second variables are for first and second digital content components of an instance of digital content to be generated after completing the first and second experiments.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable individually, together, and/or combined in different ways. Thus, individual functionality, features, and concepts described in relation to different example environments, devices, components, figures, and procedures herein are usable in any suitable combinations and are not limited to the particular combinations represented by the enumerated examples in this description.

### Example Procedures

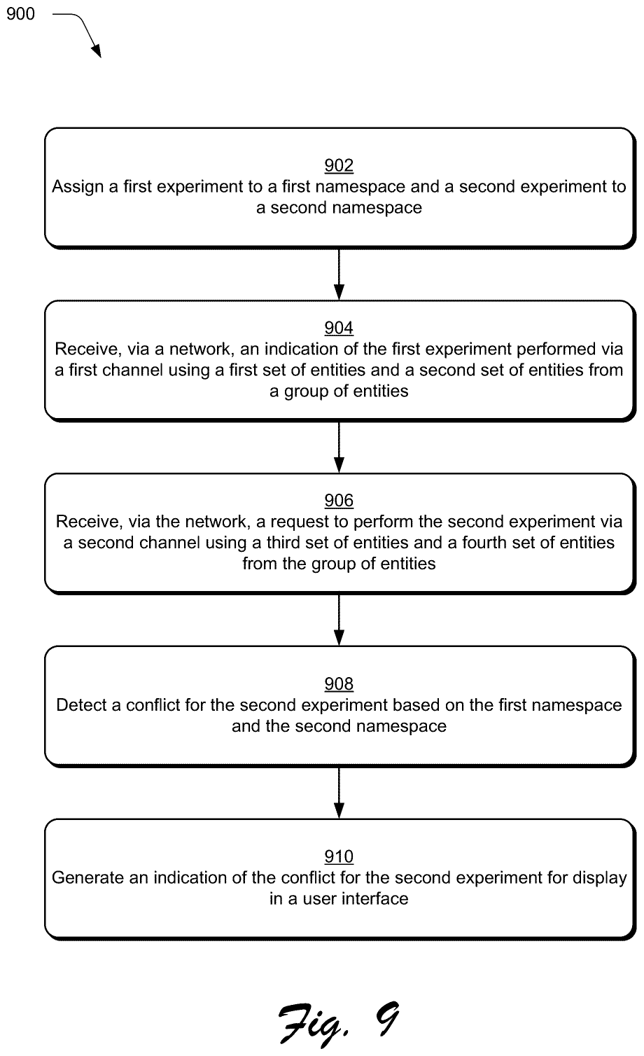

The following discussion describes techniques which are implementable utilizing the previously described systems and devices. Aspects of each of the procedures are implementable in hardware, firmware, software, or a combination thereof. The procedures are shown as a set of blocks that specify operations performed by one or more devices and are not necessarily limited to the orders shown for performing the operations by the respective blocks. In portions of the following discussion, reference is made to FIGS. 1-8. FIG. 9 is a flow diagram depicting a procedure 900 in an example implementation in which a conflict is detected for a second experiment based on a first namespace and a second namespace.

A first experiment is assigned to a first namespace and a second experiment is assigned to a second namespace (block 902). For example, the computing device 102 implements the management module 110 to assign the first experiment to the first namespace and the second experiment to the second namespace. An indication is received via a network of the first experiment performed via a first channel using a first set of entities and a second set of entities from a group of entities (block 904). In an example, the management module 110 receives the indication of the first experiment performed via the first channel.

A request is received via the network to perform the second experiment via a second channel using a third set of entities and a fourth set of entities of the group of entities (block 906). In some examples, the computing device 102 implements the management module 110 to receive the request to perform the second experiment via the second channel. A conflict is detected for the second experiment based on the first namespace and the second namespace (block 908). The management module 110 detects the conflict for the second experiment in one example. An indication of the conflict for the second experiment is generated for display in a user interface (block 910). For example, the management module 110 generates the indication of the conflict for the second experiment for display in the user interface.

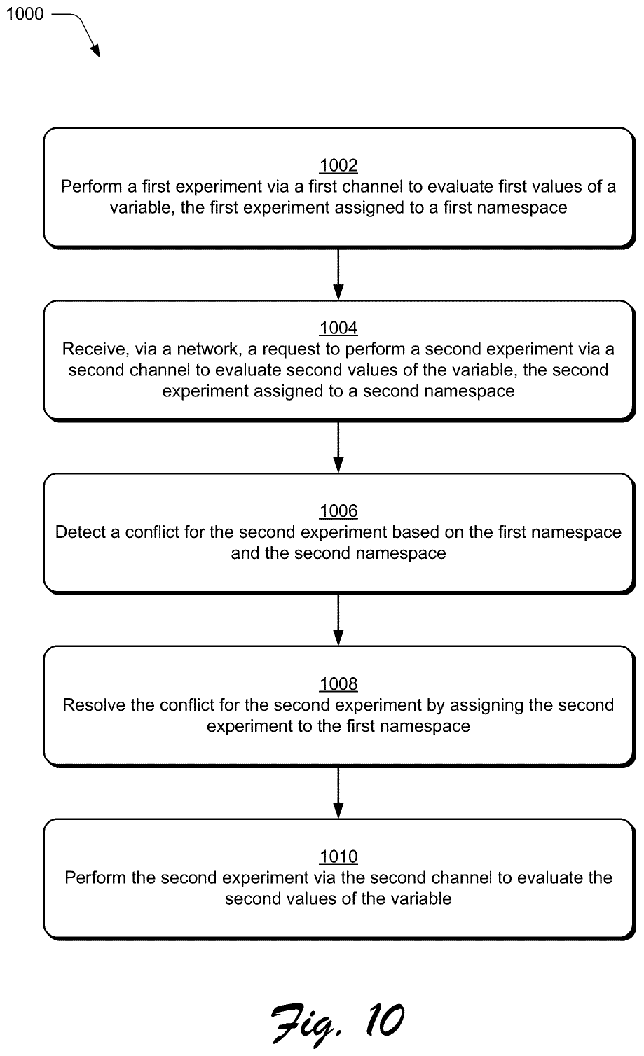

FIG. 10 is a flow diagram depicting a procedure 1000 in an example implementation in which an indication of a conflict for a second experiment is generated for display in a user interface. A first experiment is performed via a first channel to evaluate first values of a variable, the first experiment is assigned to a first namespace (block 1002). In an example, the computing device 102 implements the management module 110 to perform the first experiment via the first channel. A request is received via a network to perform a second experiment via a second channel to evaluate second values of the variable, the second experiment is assigned to a second namespace (block 1004). For example, the management module 110 receives the request to perform the second experiment via the second channel.

A conflict is detected for the second experiment based on the first namespace and the second namespace (block 1006). In one example, the computing device 102 implements the management module 110 to detect the conflict for the second experiment. The conflict for the second experiment is resolved by assigning the second experiment to the first namespace (block 1008). In some examples, the management module 110 resolves the conflict for the second experiment. The second experiment is performed via the second channel to evaluate the second values of the variable (block 1010). In an example, the management module 110 performs the second experiment via the second channel.

### Example System and Device

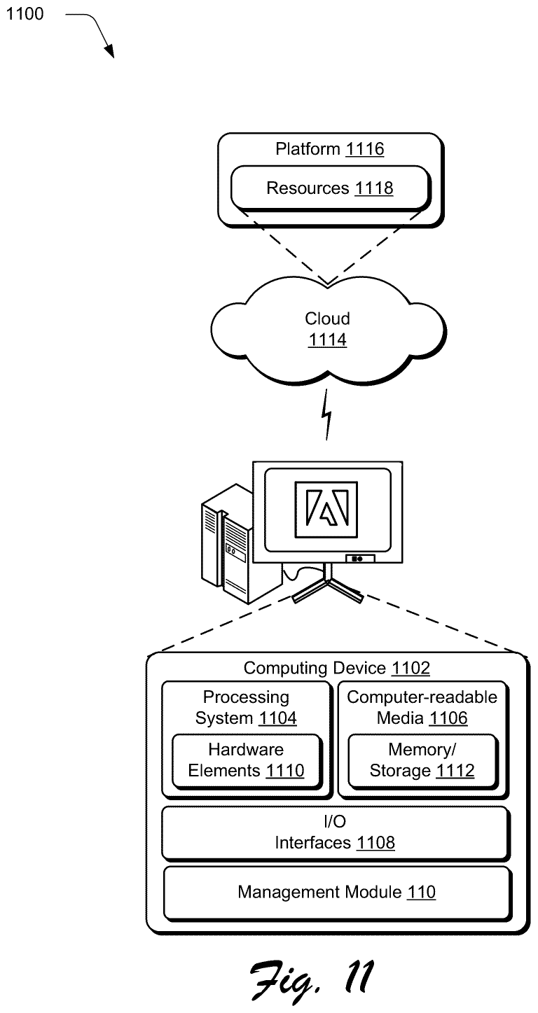

FIG. 11 illustrates an example system 1100 that includes an example computing device that is representative of one or more computing systems and/or devices that are usable to implement the various techniques described herein. This is illustrated through inclusion of the management module 110. The computing device 1102 includes, for example, a server of a service provider, a device associated with a client (e.g., a client device), an on-chip system, and/or any other suitable computing device or computing system.

The example computing device 1102 as illustrated includes a processing system 1104, one or more computer-readable media 1106, and one or more I/O interfaces 1108 that are communicatively coupled, one to another. Although not shown, the computing device 1102 further includes a system bus or other data and command transfer system that couples the various components, one to another. For example, a system bus includes any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1104 is representative of functionality to perform one or more operations using hardware. Accordingly, the processing system 1104 is illustrated as including hardware elements 1110 that are configured as processors, functional blocks, and so forth. This includes example implementations in hardware as an application specific integrated circuit or other logic device formed using one or more semiconductors. The hardware elements 1110 are not limited by the materials from which they are formed or the processing mechanisms employed therein. For example, processors are comprised of semiconductor(s) and/or transistors (e.g., electronic integrated circuits (ICs)). In such a context, processor-executable instructions are, for example, electronically-executable instructions.

The computer-readable media 1106 is illustrated as including memory/storage 1112. The memory/storage 1112 represents memory/storage capacity associated with one or more computer-readable media. In one example, the memory/storage 1112 includes volatile media (such as random access memory (RAM)) and/or nonvolatile media (such as read only memory (ROM), Flash memory, optical disks, magnetic disks, and so forth). In another example, the memory/storage 1112 includes fixed media (e.g., RAM, ROM, a fixed hard drive, and so on) as well as removable media (e.g., Flash memory, a removable hard drive, an optical disc, and so forth). The computer-readable media 1106 is configurable in a variety of other ways as further described below.

Input/output interface(s) 1108 are representative of functionality to allow a user to enter commands and information to computing device 1102, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which employs visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1102 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are implementable on a variety of commercial computing platforms having a variety of processors.

Implementations of the described modules and techniques are storable on or transmitted across some form of computer-readable media. For example, the computer-readable media includes a variety of media that is accessible to the computing device 1102. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which are accessible to a computer.

“Computer-readable signal media” refers to a signal-bearing medium that is configured to transmit instructions to the hardware of the computing device 1102, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1110 and computer-readable media 1106 are representative of modules, programmable device logic and/or fixed device logic implemented in a hardware form that is employable in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also employable to implement various techniques described herein. Accordingly, software, hardware, or executable modules are implementable as one or more instructions and/or logic embodied on some form of computer-readable storage media and/or by one or more hardware elements 1110. For example, the computing device 1102 is configured to implement particular instructions and/or functions corresponding to the software and/or hardware modules. Accordingly, implementation of a module that is executable by the computing device 1102 as software is achieved at least partially in hardware, e.g., through use of computer-readable storage media and/or hardware elements 1110 of the processing system 1104. The instructions and/or functions are executable/operable by one or more articles of manufacture (for example, one or more computing devices 1102 and/or processing systems 1104) to implement techniques, modules, and examples described herein.

The techniques described herein are supportable by various configurations of the computing device 1102 and are not limited to the specific examples of the techniques described herein. This functionality is also implementable entirely or partially through use of a distributed system, such as over a “cloud” 1114 as described below.

The cloud 1114 includes and/or is representative of a platform 1116 for resources 1118. The platform 1116 abstracts underlying functionality of hardware (e.g., servers) and software resources of the cloud 1114. For example, the resources 1118 include applications and/or data that are utilized while computer processing is executed on servers that are remote from the computing device 1102. In some examples, the resources 1118 also include services provided over the Internet and/or through a subscriber network, such as a cellular or Wi-Fi network.

The platform 1116 abstracts the resources 1118 and functions to connect the computing device 1102 with other computing devices. In some examples, the platform 1116 also serves to abstract scaling of resources to provide a corresponding level of scale to encountered demand for the resources that are implemented via the platform. Accordingly, in an interconnected device embodiment, implementation of functionality described herein is distributable throughout the system 1100. For example, the functionality is implementable in part on the computing device 1102 as well as via the platform 1116 that abstracts the functionality of the cloud 1114.

### CONCLUSION

Although implementations of systems for detecting and managing conflicts for multiple experiments have been described in language specific to structural features and/or methods, it is to be understood that the appended claims are not necessarily limited to the specific features or methods described. Rather, the specific features and methods are disclosed as example implementations of systems for detecting and managing conflicts for multiple experiments, and other equivalent features and methods are intended to be within the scope of the appended claims. Further, various different examples are described and it is to be appreciated that each described example is implementable independently or in connection with one or more other described examples.

What is claimed is:

1. A method comprising:
assigning, by a processing device, a first experiment to a first namespace and a second experiment to a second namespace;
receiving, by the processing device via a network, an indication of the first experiment performed via a first channel using a first set of entities and a second set of entities from a group of entities;
receiving, by the processing device via the network, a request to perform the second experiment via a second channel using a third set of entities and a fourth set of entities from the group of entities;
detecting, by the processing device, a conflict for the second experiment based on the first namespace and the second namespace; and
generating, by the processing device, an indication of the conflict for the second experiment for display in a user interface.

2. The method as described in claim 1, wherein assigning the second experiment to the first namespace resolves the conflict for the second experiment.

3. The method as described in claim 2, wherein the first experiment evaluates a first value of a variable and the second experiment evaluates a second value of the variable.

4. The method as described in claim 1, wherein performing the second experiment in parallel with performing the first experiment resolves the conflict for the second experiment.

5. The method as described in claim 1, further comprising identifying a particular entity included in the first set of entities and the third set of entities.

6. The method as described in claim 5, wherein the particular entity is associated with a first identification for the first channel and a second identification for the second channel.

7. The method as described in claim 6, wherein the first identification and the second identification are associated with the particular entity using identity stitching.

8. The method as described in claim 5, wherein the third set of entities and the fourth set of entities are formed by segmenting the first set of entities into the third set of entities and the fourth set of entities.

9. The method as described in claim 1, further comprising:
resolving the conflict for the second experiment; and
generating a report summarizing results of the first experiment by associating a particular entity from the group of entities with a first identification for the first channel and a second identification for the second channel.

10. The method as described in claim 9, wherein the conflict for the second experiment is resolved by assigning the second experiment to the first namespace.

11. A system comprising:
a memory component; and
a processing device coupled to the memory component, the processing device to perform operations comprising:
performing a first experiment via a first channel to evaluate first values of a variable, the first experiment assigned to a first namespace;
receiving, via a network, a request to perform a second experiment via a second channel to evaluate second values of the variable, the second experiment assigned to a second namespace;
detecting a conflict for the second experiment based on the first namespace and the second namespace;
resolving the conflict for the second experiment by assigning the second experiment to the first namespace; and
performing the second experiment via the second channel to evaluate the second values of the variable.

12. The system as described in claim 11, wherein the operations further comprise generating a report summarizing results of the first experiment by associating a particular entity with a first identification for the first channel and a second identification for the second channel.

13. The system as described in claim 12, wherein the first identification and the second identification are associated with the particular entity using identity stitching.

14. The system as described in claim 11, wherein the operations further comprise:
receiving a request to perform a third experiment using a set of entities used to perform the first experiment; and
performing the third experiment using the set of entities used to perform the first experiment.

15. The system as described in claim 14, wherein the third experiment is assigned to the second namespace.

16. A non-transitory computer-readable storage medium storing executable instructions, which when executed by a processing device, cause the processing device to perform operations comprising:
assigning a first experiment to a first namespace and a second experiment to a second namespace;
receiving, via a network, an indication of the first experiment performed via a first channel using a first set of entities and a second set of entities from a group of entities;
receiving, via the network, a request to perform the second experiment via a second channel using a third set of entities and a fourth set of entities from the group of entities;
detecting a conflict for the second experiment based on the first namespace and the second namespace; and
generating an indication of the conflict for the second experiment for display in a user interface.

17. The non-transitory computer-readable storage medium as described in claim 16, wherein assigning the second experiment to the first namespace resolves the conflict for the second experiment.

18. The non-transitory computer-readable storage medium as described in claim 16, wherein the conflict for the second experiment is detected by determining that the first experiment evaluates a first value of a variable and the second experiment evaluates a second value of the variable.

19. The non-transitory computer-readable storage medium as described in claim 16, wherein the operations further comprise identifying a particular entity included in the first set of entities and the third set of entities using identity stitching.

20. The non-transitory computer-readable storage medium as described in claim 16, wherein particular entity is associated with a first identification for the first channel and a second identification for the second channel.
